(19) United States
(12) Patent Application Publication
(10) Pub. No.: US 2005/0018443 A1
(43) Pub. Date: Jan. 27, 2005

(54) Lamp unit for forming a cut-off line and vehicular headlamp using the same

(76) Inventor: Hironori Tsukamoto, Shizuoka (JP)

Correspondence Address: Jonathan P. Osha;Osha & May LLP., Suite 2800, 1221 McKinney St., Houston, TX, 77010, US

(21) Appl. No.: 10/894,699

(22) Filed: Jul. 20, 2004

(30) Foreign Application Priority Data
Jul. 24, 2003 (JP) P 2003-278774

(51) Int. Cl. B60Q 1/04

(52) U.S. Cl. 362/539; 362/545; 362/282

(57) ABSTRACT

A lamp unit for a vehicular headlamp includes a semiconductor light emitting element, a projection lens on an optical axis of the light emitting element, and a light shielding member disposed such that an upper edge of the shielding member is positioned in the proximity of a focal point in the rear of the projection lens. The light radiated from the semiconductor light emitting element is partially shielded by the light shielding member 24 and the partially shielded light is irradiated forward via the projection lens such that a part of the horizontal cut-off line is formed as an inversed image of a shape of the upper edge of the light shielding member.

### BACKGROUND OF INVENTION

1. Field of the Invention

The invention relates generally to a lamp unit and the like employed in a vehicular headlamp for forming a cut-off line.

2. Background Art

As disclosed in Patent Document 1, a vehicular headlamp has been known, as structured to form the geometry of a light distribution pattern having a cut-off line at its upper zone through radiation of light from a plurality of lamp units.

Also, Patent Document 2 discloses a linear light source unit, in which a plurality of light emitting diodes are arranged in a linier group, structured to reflect the light from the linear light source unit forward by a predetermined reflecting member.

Patent Document 1: JP-2001-270383-A

Patent Document 2: JP-2003-31011-A

In the case where the linear light source unit disclosed in Patent Document 2 is applied to the vehicular headlamp, it may be possible to make the structure downsized and to form the geometry of the light distribution pattern having the cut-off line at the upper zone. However, this causes difficulty obtaining clear cut-off lines.

### SUMMARY OF INVENTION

In view of the aforementioned drawback, an object of the present invention is to provide a lamp unit used in a vheicular headlamp for forming a cut-off line, which is capable of forming a clear cut-off line with a simple structure.

The object of the present invention will be achieved by use of a semiconductor light emitting element as a light source, a predetermined light shielding member, and a projection lens.

According to the present invention, a lamp unit is employed for a vehicular headlamp structured to form the geometry of a light distribution pattern with a predetermined cut-off line at an upper zone of a radiated light. The lamp unit used to form the predetermined cut-off line includes a projection lens disposed on an optical axis that extends in a longitudianl direction of a vehicle, a light shielding member disposed proximate to a focal point in the rear of the projection lens such that an upper edge of the light shielding member is positioned proximate to the optical axis, and a semiconductor light emitting element disposed proximately behind the light shielding member. A light ray emitted from the semiconductor light emitting element, which is partially shielded by the light shielding member, is radiated forward via the projection lens so as to form a part of the cut-off line as an inverted image of a shape of the upper edge of the light shielding member.

The light distribution pattern having a predetermined cut-off line at the upper portion thereof may be typically applied to a so-called low-beam distribution pattern. However, it may be applied to any other light distribution pattern.

The geometry of a predetermined cut-off line is not limited to a specific one. It may be formed of a combination of a horizontal cut-off line that extends horizontally and an oblique cut-off line that extends obliquely upward from the horizontal cut-off line. Further, it may be formed of a plurality of pairs of right and left horizontal cut-off lines arranged stepwise.

The “lamp unit” is structured to “form a part of the cut-off line.” The other part of the cut-off line may be formed by radiation of light from the same types of the lamp units, as discussed above, or other types of lamp units.

The “light shielding member” is not limited to a specific structure although, preferably, it is disposed proximate in the rear of a focal point in the rear of the projection lens such that the upper edge of the light shielding member is positioned proximate to the optical axis.

The “semiconductor light emitting element” is not also limited to a specific type. For example, a light emitting diode, a laser diode and the like may be employed.

As mentioned above, the lamp unit is used to form the predetermined cut-off line includes a projection lens disposed on an optical axis that extends in a longitudinal direction of a vehicle, a light shielding member disposed in the proximity of a focal point in the rear of the projection lens such that an upper end edge is positioned proximate to the optical axis, and a semiconductor light emitting element positioned behind the light shielding member. Thus, a light ray emitted from the semiconductor light emitting element, which is partially shielded by the light shielding member, is radiated forward via the projection lens so as to form a part of the cut-off line as an inverted image of a shape of the upper edge of the light shielding member. Accordingly, this allows the lamp unit to provide a clear cut-off line. The semiconductor light emitting element is employed as the light source, and the light shielding member is provided around the light source to the front thereof. The projection lens is further provided to the front of the light shielding member. This may allow the lamp unit to be downsized.

According to the present invention, the lamp unit employed in the vehicular headlamp may be downsized, and capable of forming a clear cut-off line.

If the lamp unit has a structure including a plurality of the semiconductor light emitting elements and a plurality of the light shielding members, the light level of the radiated light from the lamp unit may further increase and a number of the cut-off line may be created.

Also, if at least two of the light shielding members have the upper edges each formed in a different shape, an arbitrary geometry of the cut-off line may be easily formed by the radiated light from the lamp unit.

In this case, if the plurality of the light shielding members are integrally formed, the positional relationship among those light shielding members can be accurately adjusted so as to form the cut-off line with accuracy.

If the vehicular headlamp is provided with a plurality of the lamp units according to the present invention, the headlamp itself can be downsized and in addition to obtaining the light distribution pattern with clear cut-off lines.

Other aspects and advantages of the invention will be apparent from the following description and the appended claims.

### BRIEF DESCRIPTION OF DRAWINGS

FIG. 1 is a front view of a vehicular headlamp including a plurality of lamp units according to an embodiment of the present invention.

FIG. 2 diagrammatically shows the profile of light distribution patterns on the virtual vertical screen formed by light radiated from a light source according to an embodiment of the invention.

FIG. 3 is a partially enlarged view of FIG. 1, representing one of the lamp units to form horizontal cut-off lines of the vehicular headlamp.

FIG. 4 is a cross-sectional side view showing the lamp unit shown in FIG. 3.

FIG. 5 is a plan view showing the lamp unit shown in FIG. 3.

FIG. 6 is a perspective view to illustrate the profile of a light distribution pattern on the virtual vertical screen formed by light radiated from the lamp unit shown in FIG. 3.

FIG. 7 is a cross-sectional side view showing another lamp unit to form a horizontal cut-off line.

FIG. 8 is a partially enlarged view of FIG. 1, representing one of the lamp units of to form oblique cut-off lines.

FIG. 9 is a perspective view to illustrate the profile of a light distribution pattern on the virtual vertical screen formed by light radiated from the lamp unit shown in FIG. 8.

FIG. 10 is a cross-sectional side view of FIG. 1, representing one of the lamp units to form diffusion area.

FIG. 11 is a perspective view to illustrate the profile of a diffusion area formed by light radiated from the lamp unit shown in FIG. 10.

FIG. 12 is a partially enlarged view of a lamp unit according to an modified example of an embodiment of the invention.

FIG. 13 is a plan view showing the lamp units shown in FIG. 12.

FIG. 14 is a perspective view to illustrate the profile of light distribution patterns on the virtual vertical screen formed by light radiated from the lamp unit shown in FIG. 12.

FIG. 15 is a partially enlarged front view of a lamp unit according to the other modified example of an embodiment of the invention.

FIG. 16 is a perspective view to illustrate the profile of a light distribution patterns on the virtual vertical screen formed by light radiated from the lamp unit shown in FIG. 15.

### DETAILED DESCRIPTION

Embodiments of the present invention will be described referring to the drawings.

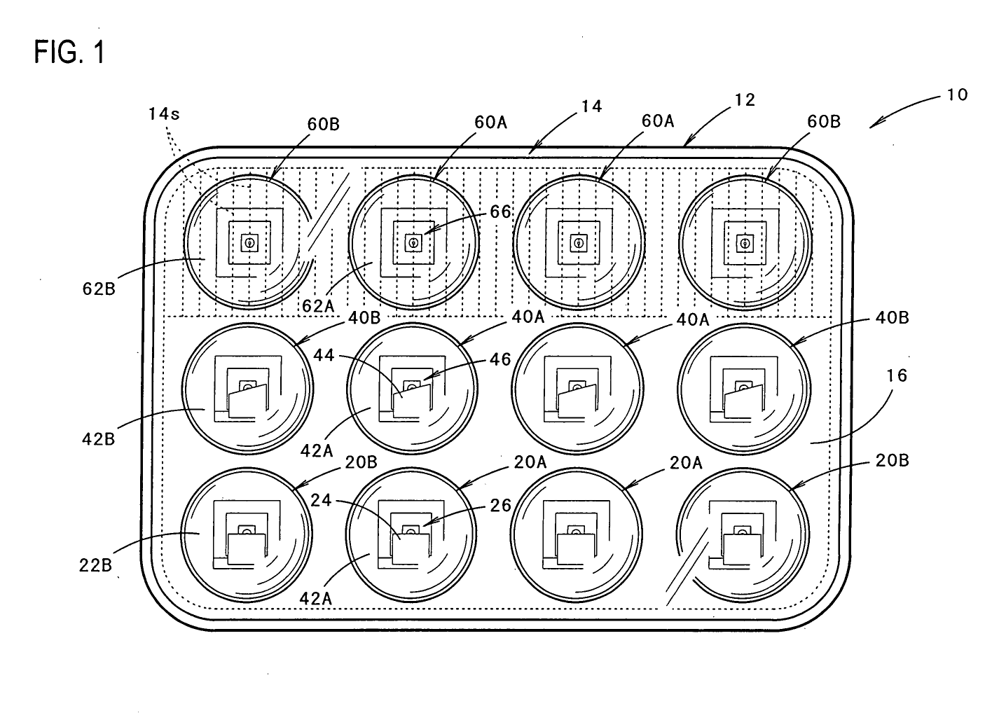

FIG. 1 is a front view of a vehicular headlamp according to an embodiment of the present invention.

Referring to FIG. 1, a vehicular headlamp 10 according to the present invention has twelve lamp units arranged vertically in three stages within a lamp chamber formed of a lamp body 12 and a translucent cover 14 attached to an opening of the front end of the lamp body 12. Specifically, four lamp units 20A and 20B are aligned in the lower stage, four lamp units 40A and 40B are aligned in the middle stage, and four lamp units 60A and 60B are aligned in the upper stage.

Most part of the translucent cover 14 is formed in a plain configuration. The upper area of the translucent cover 14 has a plurality of diffusion lens elements aligned like vertical stripes so as to diffuse the radiated light from the four lamp units 60A and 60B in the upper stage. An inner panel 16 is disposed in the rear of the translucent cover 14 so as to surround the twelve lamp units.

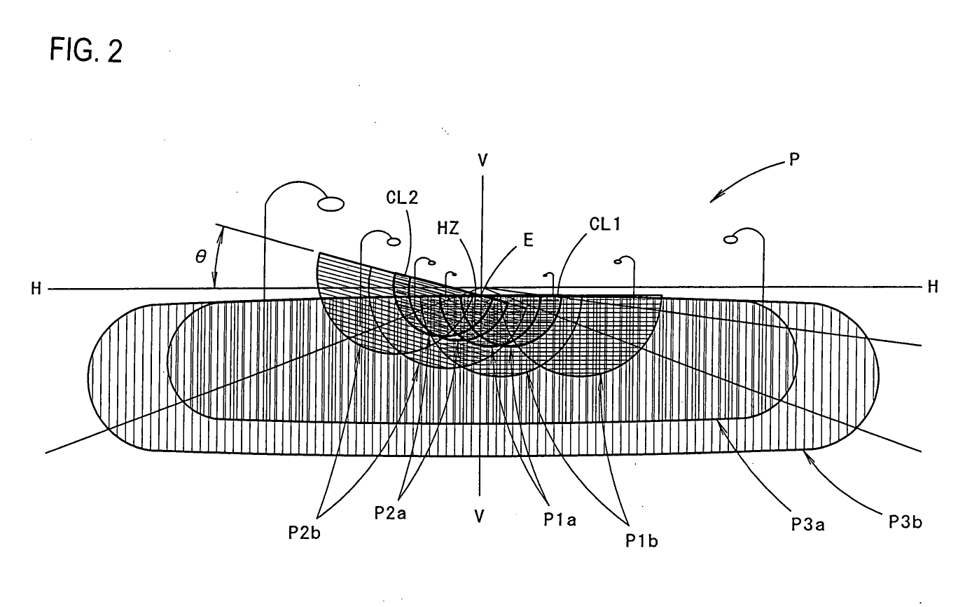

FIG. 2 diagrammatically shows the geometry of light distribution patterns P on a virtual vertical screen, which is placed ahead at the distance of 25 meters, formed by light radiated forward from the vehicular headlamp 10.

The light distribution pattern P indicates a low beam light distribution pattern for the left-side light distribution. The pattern P has a horizontal cut-off line CL1 at the upper zone and an oblique cut-off line CL2 that extends at a predetermined angle θ (e.g., θ=15 degrees) with respect to the horizontal cut-off line CL1. An elbow point E as an intersection of the cut-off lines CL1 with CL2 is at a position downward of H-V as a vanishing point to the front of the lamp unit at about 0.5 to 0.6 degrees. A hot zone HZ as an area of high-intensity light is formed to surround the elbow point E slightly leftward.

The light distribution pattern P is formed by composition of light distribution patterns, which are defined by patterns P1a and P1b to form the horizontal cut-off line, patterns P2a and P2b to form the oblique cut-off line, and patterns P3a and P3b to form the diffusion area respectively.

The patterns P1a and P1b are distribution light patterns to form horizontal cut-off lines CL1. The patterns P1 and P2 are formed by the light radiated from the four lamp units 20A and 20B in the lower stage. The patterns P1a, that is, two patterns to form the horizontal cut-off line formed by the two lamp units 20A positioned in the center are proximate to the elbow point E. The patterns P1a are relatively small and bright patterns. The pattern P1b, that is, two patterns to form the horizontal cut-off line formerd by the two lamp units 20B positioned at both sides of the stage are placed to surround the two patterns P1a rightward. The patterns P1b are relatively large patterns.

The patterns P2a and P2b are distribution light patterns to form the oblique cut-off lines CL2. Those patterns are formed by the light radiated from the four lamp units 40A and 40B aligned in the middle stage. The relatively small and bright patterns P2a, that is, two patterns to form the oblique cut-off line formed by the two lamp units 40A positioned in the center are proximate to the elbow point E. The relatively large patterns P2b, that is, two patterns to form the oblique cut-off line formerd by the two lamp units 40B positioned at both sides of the row are placed to surround the two patterns P2a leftward.

The patterns P3a and P3b are distribution light patterns to form the diffusion area of the light distribution pattern P. The patterns P3a and P3b are formed to widely diffuse in a lateral direction below the horizontal cut-off line CL1. The patterns P3a and P3b are formed by a plurality of diffusion lens elements 14s that laterally diffuses the light radiated from the four lamp units 60A and 60B in the upper stage. The lateral diffusion angle of the pattern P3b to form the diffusion area formed by the lamp units 20B positioned at both sides of the row is larger than that of the pattern P3a formed by the lamp units 20A in the center of the row.

Specific structure of each of the lamp units 20A, 20B, 40A, 40B, 60A and 60B will be described below. Each structure of the lamp units 20A and 20B to form horizontal cut-off lines will be described first.

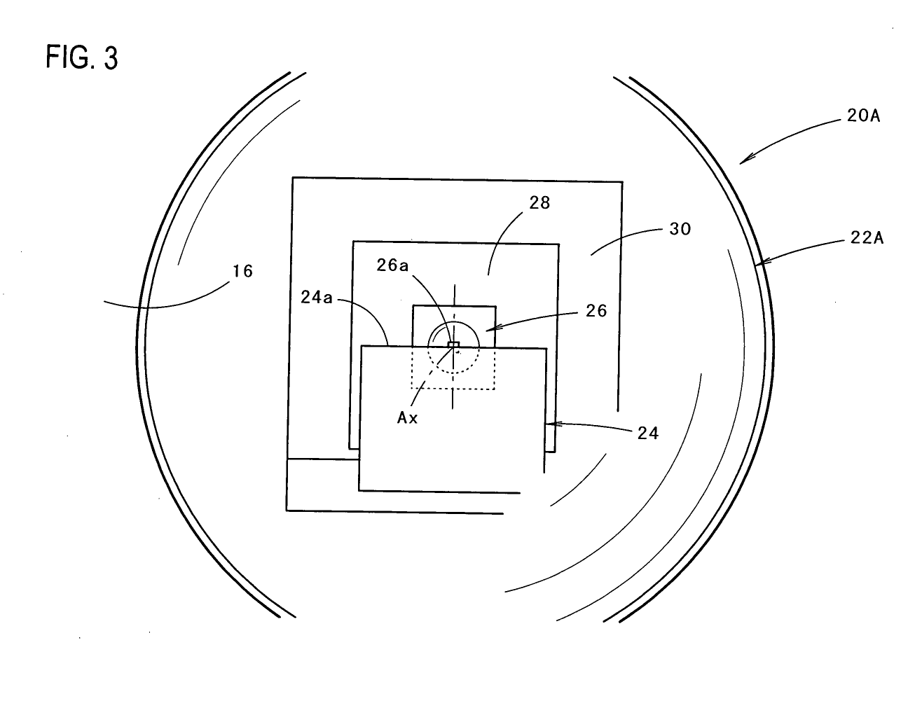

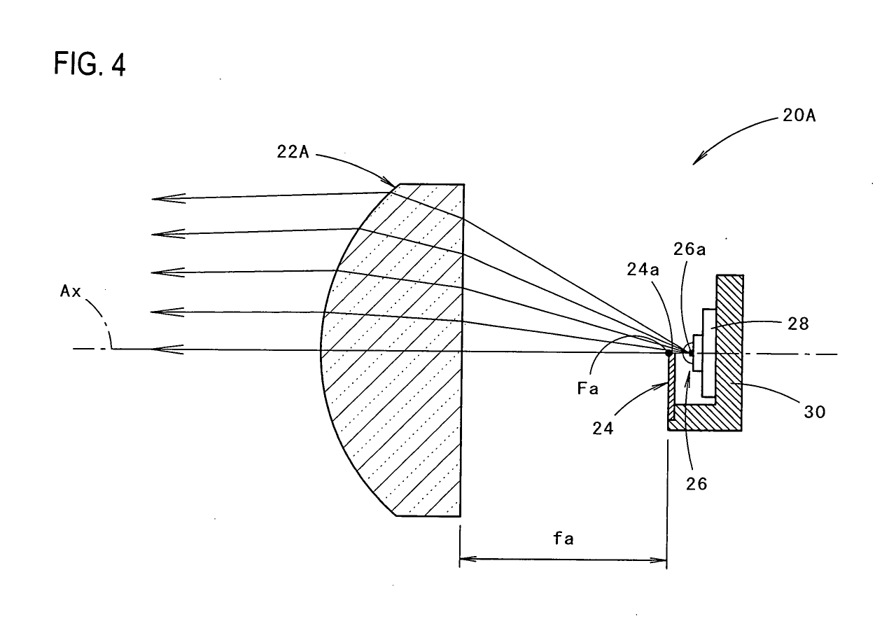

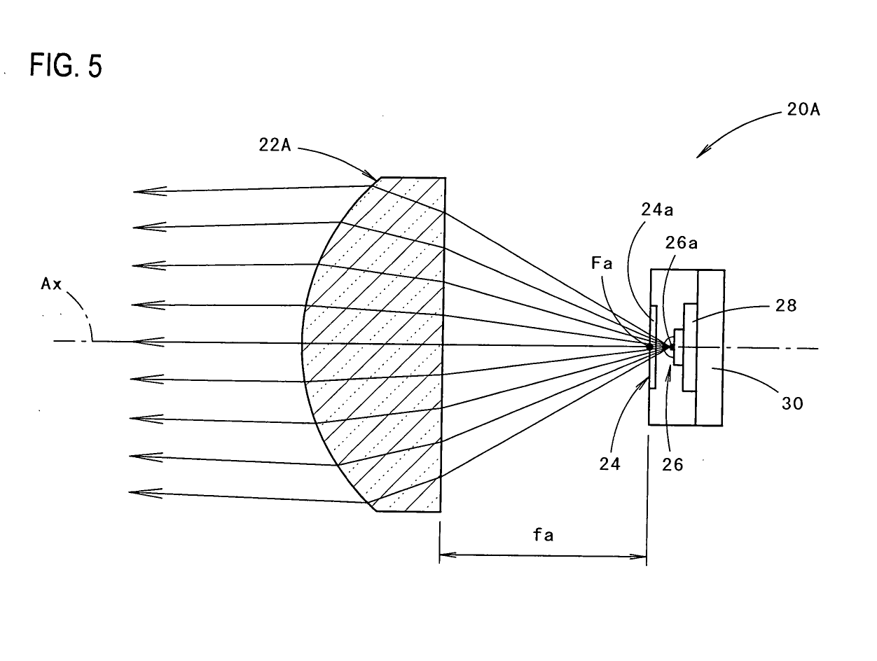

FIG. 3 is a partially enlarged view of one of the lamp units 20A shown in FIG. 1. FIGS. 4 and 5 are a cross-sectional side view and a plan view showing the lamp unit 20A as a single unit, respectively.

As shown in FIGS. 4 and 5, the lamp unit 20A includes a projection lens 22A disposed on an optical axis Ax that extends in a longitudinal direction of a vehicle, a light shielding member 24 disposed in the rear of focal point Fa of the projection lens 22A, and a semiconductor light emitting element 26 disposed around the position behind the light shielding member 24.

The projection lens 22A is formed of a plane-convex lens with a convex surface at the front side and with a plane surface at the rear side. The focal distance fa thereof is set to a relatively large value. The projection lens 22A is fixedly attached to a support member 30 via a connecting member (not shown). The light shielding member 24 is formed as a plate-like member that extends along the vertical surface that orthogonally crosses the optical axis Ax. An upper edge 24a of the light shielding member 24 is fixedly attached to the support member 30 so as to horizontally pass across the optical axis Ax in the horizontal direction. The semiconductor light emitting element 26 is a light emitting diode that emits light in white, which is fixedly attached to the support member 30 via a substrate 28 such that a light emitting chip 26a is directed to the front of the lamp unit on the optical axis Ax.

In the lamp unit 20A, the light emitted forward from the semiconductor light emitting element 26 is inverted with the projection lens 22A, which causes the transmitted light therein to slightly converges into the optical axis Ax. The light emitted from the semiconductor light emitting element 26, which is directed downward of the optical axis Ax is shielded by the light shielding member 24. This prevents the lamp unit 20A from radiating light upward.

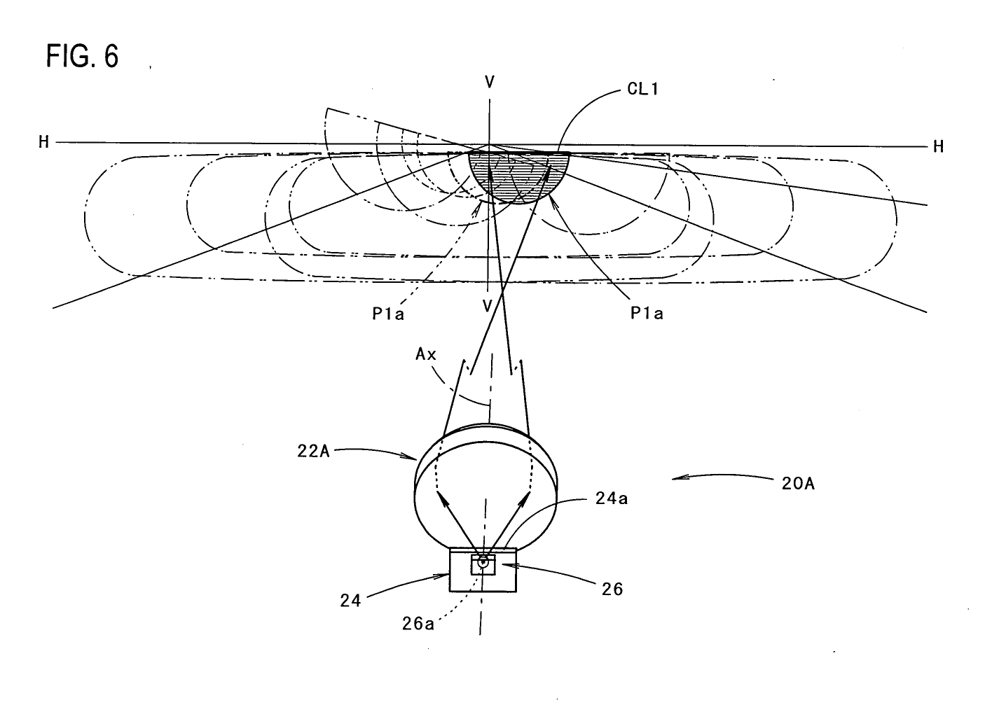

FIG. 6 is a perspective view to illustrate the geometry of a light distribution pattern on the virtual vertical screen formed by light radiated from the lamp unit shown in FIG. 3 when perspectively seen from backside.

As shown in the figure, the lamp unit 20A serves to form the pattern P1a that includes a part of the horizontal cut-off line CL1, as is the inverted image of the upper edge 24a of the light shielding member 24. The lamp unit 20A is positioned such that the optical axis Ax extends slightly downward and rightward with respect to the longitudinal direction of the vehicle. The orientation of the optical axis As is horizontally offset between the two lamp units 20A. As a result, the two patterns P la having horizontal cut-off lines can be obtained.

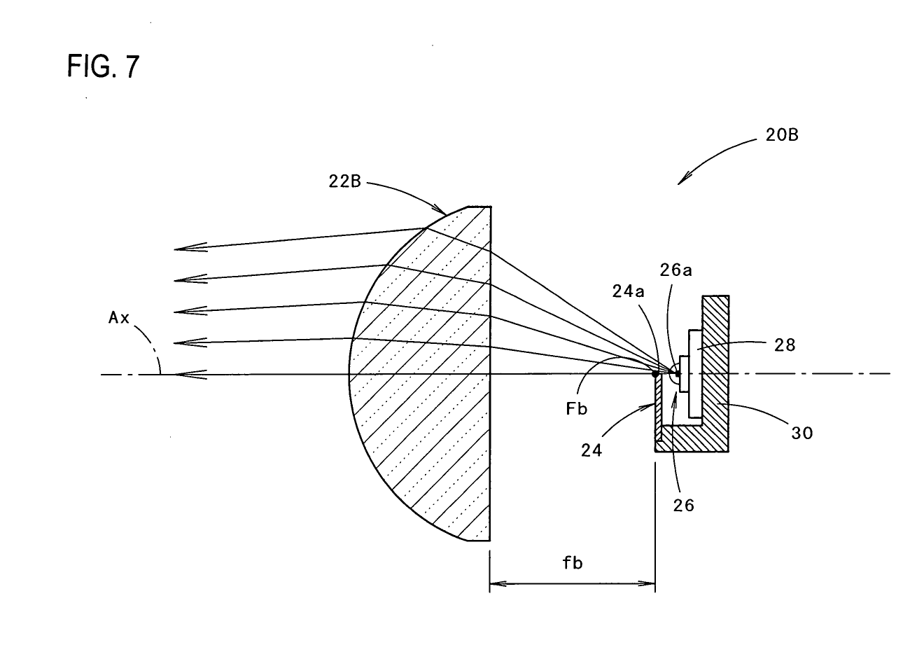

FIG. 7 is a cross-sectional side view showing the lamp unit 20B as a single unit.

Referring to the figure, the lamp unit 20B has a similar structure with the lamp unit 20A. The projection lens 22B has a different focal distance. Specifically, the focal distance fb of the projection lens 22B is set to be shorter than the focal distance fa of the projection lens 22A of the lamp unit 20A. The light shielding member 24 is disposed in the rear of the focal point Fb of the projection lens 22B as in the lamp unit 20A.

In the lamp unit 20B, the light emitted forward from the semiconductor light emitting element 26 is inverted with the projection lens 22B, which causes the transmitted light therein to converge into the optical axis Ax, compared with the projection lens 22A. Thus, this allows the lamp unit 20B to form the patterns P1b, which are larger than the patterns P1a, as shown in FIG. 2. Further, the lamp unit 20B is configured such that the optical axis Ax extends slightly downward and rightward with respect to the longitudinal direction of the vehicle. The orientation of the optical axis Ax is horizontally offset between those two lamp units 20B so as to form two patterns P1b for forming horizontal cut-off lines.

Next, each structure of the lamp units 40A and 40B to form oblique cut-off lines will be described.

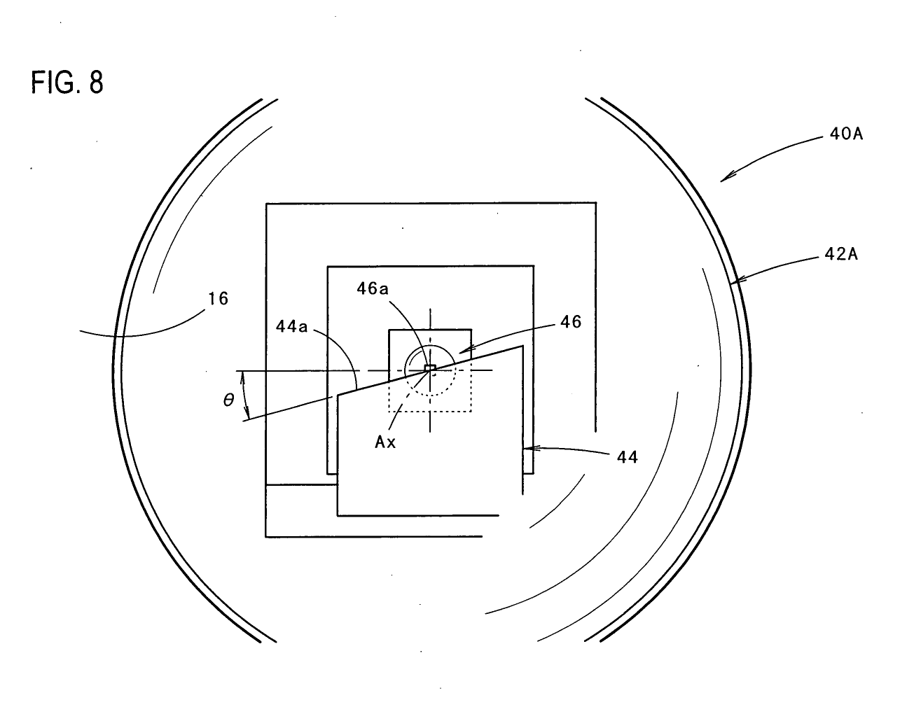

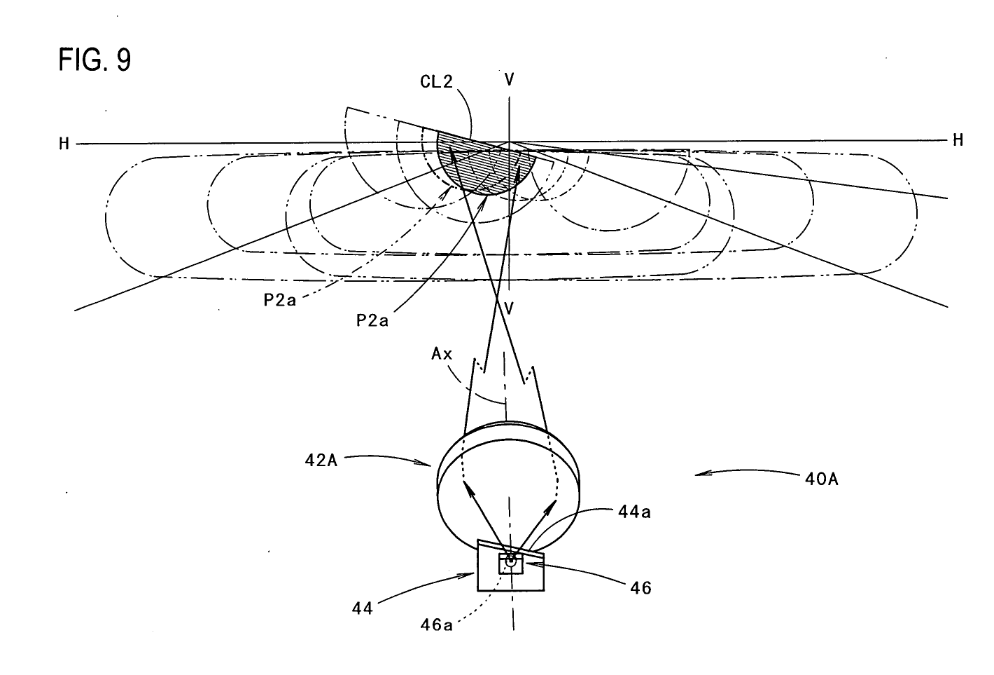

FIG. 8 is a partially enlarged view of the lamp unit 40A shown in FIG. 1. Also, FIG. 9 is a perspective view to illustrate the geometry of a light distribution pattern on the virtual vertical screen formed by the light radiated from the lamp unit 40A when perspectively seen from the backside.

Referring now to the figures, the lamp unit 40A includes a projection lens 42A provided on the optical axis Ax that extends in the longitudinal direction of the vehicle, a light shielding member 44 disposed in the rear of the focal point of the projection lens 42A, and a semiconductor light emitting element 46 disposed around a position behind the light shielding member 44. The structure of the lamp unit 40A is the similar to the lamp unit 20A, including the focal distance of the projection lens 42A, except the light shielding member 44.

The light shielding member 44 is a plate-like member that extends along the vertical surface that orthogonally intersects the optical axis Ax as well as the light shielding member 24. The upper edge 44a of the light shielding member 44 is configured to extend so as to pass on the optical axis Ax and tilt against the horizontal plane including the optical axis Ax at a predetermined angle θ.

In the lamp unit 40A, as is the case with the lamp unit 20A, the light emitted from the semiconductor light emitting element 46 is partially shielded by the light shielding member 44, and then further radiated forward via the projection lens 42A.

Referring to FIG. 9, the lamp unit 40A serves to form the patterns P2a to form oblique cut-off lines having a part of the oblique cut-off line CL2 as the inverted image of the upper end edge 44a of the light shielding member 44. The lamp unit 40A is disposed such that the optical axis Ax extends slightly downward and leftward with respect to the longitudinal direction of the vehicle. The orientation of the optical axis Ax is angularly offset between those two lamp units 40A at a predetermined angle θ, in order to form two patterns P2a having oblique cut-off lines.

In the meanwhile, the lamp unit 40B has a similar structure to the lamp unit 40A. However, the focal distance of the projection lens 42B is different from that of the lamp unit 40A. Specifically, the focal distance of the projection lens 42B is set to be shorter than the focal distance of the projection lens 42A of the lamp unit 40A. More specifically, the focal distance of the projection lens 42B is set to the value that is equal to the focal distance fb of the projection lens 22B of the lamp unit 20B.

In the lamp unit 40B, the light emitted forward from the semiconductor light emitting element 46 is inverted with the projection les 42B, which causes the transmitted light therein to converge into the optical axis Ax, compared with the projection lens 42A. As shown in FIG. 2, the patterns P2b, which are larger than the patterns P2a, are formed. The lamp unit 40B is disposed such that the optical axis Ax extends slightly downward and leftward with respect to the longitudinal direction of the vehicle. The orientation of the optical axis Ax is angularly offset between those two lamp units 40A in the direction tilted at a predetermined angle θ so as to form two patterns P2b for oblique cut-off lines.

Each structure of the lamp units 60A and 60B for forming diffusion area will be described.

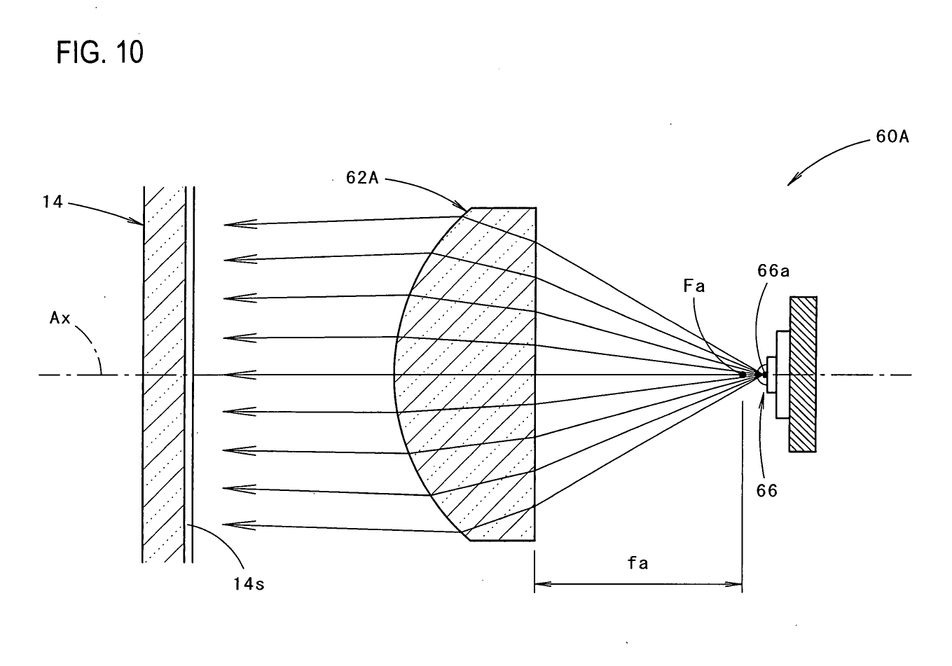

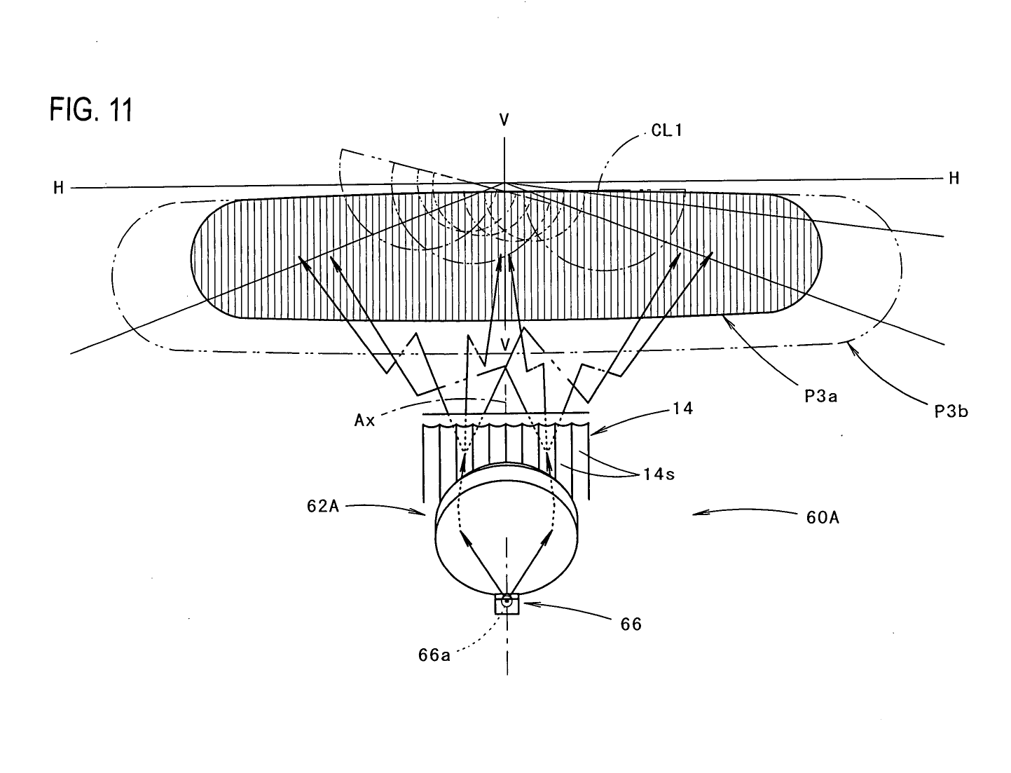

FIG. 10 is a cross-sectional side view of the lamp unit 60A together with the translucent cover 14. Further, FIG. 11 is a perspective view to illustrate the geometry of a diffusion area on the virtual vertical screen formed by the light radiated from the lamp unit 60A when perspectively seen from the backside.

As shown in the figures, the lamp unit 60A includes a projection lens 62A disposed on the optical axis Ax that extends in the longitudinal direction of the vehicle, and a semiconductor light emitting element 66 disposed around the focal point Fa in the rear of the projection lens 62A. The lamp unit 60A has a similar structure to the lamp unit 20A except that the lamp unit 60A is not provided with a light shielding member 24 as provided in the lamp unit 20A.

The lamp unit 60A is structured to radiate the light emitted forward from the semiconductor light emitting element 66 via the projection lens 62A as well as the lamp unit 20A. The light radiated from the projection lens 62A is diffused in a lateral direction by a plurality of diffusion lens elements 14s of the translucent cover 14, which are disposed in front of the projection lens 62A.

As shown in FIG. 11, the lamp unit 60A is structured to form the horizontally long pattern P3a for diffusion area based on the plurality of the diffusion lens elements 14s, which are disposed in front of the lamp unit 60A for diffusion in the lateral direction. The optical axis Ax of the lamp unit 60A is set to be oriented downward with respect to the longitudinal direction of the vehicle such that the upper edge of the pattern P3a for diffusion area does not exceed over the horizontal cut-off line CL1. The other one of those two lamp units 60A has a similar structure to the above described one.

The lamp unit 60B has a similar structure to the lamp unit 60A except that the focal distance of the projection lens 62B is different from that of the lamp unit 60A. Specifically, the focal distance of the projection lens 62B is set to be shorter than the focal distance fa of the projection lens 62A of the lamp unit 60A. More specifically, the focal distance of the projection lens 62B is set to the value that is substantially the same as the focal distance fb of the projection lens 22B of the lamp unit 20B.

In the lamp unit 60B, the light emitted forward from the semiconductor light emitting element 66 is inverted with the projection lens 62B, which causes the transmitted light therein to converge into the optical axis Ax, compared with the projection lens 62A. As a result, the pattern P3b for diffusion area is formed, which is larger than the pattern P3a. The optical axis Ax of the lamp unit 60B is set to be oriented downward in the longitudinal direction of the vehicle such that the upper edge of the pattern P3b does not exceed over the horizontal cut-off line CL1. The other of those two lamp units 60B has a similar structure to, the above described one.

As mentioned above, the vehicular headlamp 10 as described in this embodiment includes four lamp units 20A and 20B to form the horizontal cut-off line CL1 of the low beam light distribution pattern P. Further, each of the lamp units 20A and 20B includes projection lenses 22A and 22B each positioned on the optical axis Ax that extends in the longitudinal direction of the vehicle, the light shielding members 24 each disposed in the proximity of the focal points in the rear of the projection lens 22A and 22B such that each of the upper edges of the light shielding members 24 is positioned proximate to the optical axis Ax, and the semiconductor light emitting element 26 disposed behind the light shielding member 24. Thus, the light emitted from the semiconductor light emitting element 26 is partially chopped by the light shielding member 24, and the partially chopped light by the light shielding member 24 is further transmitted forward via the projection lenses 22A and 22B such that a part of the horizontal cut-off line CL1 is formed as the inverted image of the shape of the upper edge of the light shielding member 24. As a result, the clear horizontal cut-off line CL1 may be obtained. Additionally, the semiconductor light emitting element 26 is employed as the light source, and the light shielding member 24 is disposed in front of the semiconductor light emitting element 26. Each of the projection lenses 22A and 22B is disposed in front of the light shielding member 24. Accordingly, the aforementioned structure allows each of the lamp units 20A and 20B to be compact.

Also, the vehicular headlamp 10 as described in this embodiment includes four lamp units 40A and 40B to form the oblique cut-off line CL2 of the low beam light distribution pattern P. Further, each of the lamp units 40A and 40B includes projection lenses 42A and 42B each positioned on the optical axis Ax that extends in the longitudinal direction of the vehicle, the light shielding members 44 each disposed in the proximity of the focal points in the rear of the projection lenses 42A and 42B such that each of the upper edges of the light shielding members 44 is proximate to the optical axis Ax, and the semiconductor light emitting element 46 disposed behind the light shielding member 44. Thus, the light emitted from the semiconductor light emitting element 46 is partially shielded by the light shielding member 44, and the light partially shielded by the light shielding member 44 is further transmitted forward via the projection lenses 42A and 42B such that the oblique cut-off line CL2 is partially formed as the inverted image of the shape of the upper edge of the light shielding member 44. As a result, the clear oblique cut-off line CL2 may be obtained. Additionally, the semiconductor light emitting element 46 is employed as the light source, and the light shielding member 44 is disposed in front of the semiconductor light emitting element 46. Each of the projection lenses 42A and 42B is provided to the front of the light shielding member 44. Accordingly, the aforementioned structure allows each of the lamp units 40A and 40B to be compact.

As mentioned above, this embodiment allows each of the lamp units 20A, 20B, 40A, and 40B to be downsized and also provide the low beam light distribution pattern P that combines the clear horizontal cut-off line CL1 and oblique cut-off line CL2.

According to the embodiment, each of the lamp units 60A and 60B has substantially the same structure as that of each of those lamp units 20A, 20B, 40A and 40B for horizontal and oblique cut-off lines. Accordingly, the vehicular headlamp 10 may be downsized.

As each of the projection lenses 22A and 22B of the lamp units 20A and 20B for horizontal cut-off lines is set to the different focal distance fa and fb, the resultant geometry of the patterns P1a and P1b have different sizes. This allows the light intensity distribution of the low beam light distribution pattern P around the horizontal cut-off line CL1 to be uniformed while ensuring sufficient distant visibility on the road ahead.

In addition, as each of the projection lenses 42A and 42B of the lamp units 40A and 40B for oblique cut-off lines are set to the values fa and fb that are in different, the resultant geometry of the patterns P2a and P2b have different sizes. This allows the light intensity distribution of the low beam light distribution pattern P around the oblique cut-off line CL2 to be uniformed while ensuring sufficient distant visibility on the road ahead.

Further, as each of the projection lenses 62A and 62B of the lamp units 60A and 60B for diffusion area have different focal distances fa and fb, the resultant geometry of the patterns P3a and P3b area have different sizes. This allows the lamp units 60A and 60B to widely radiate light to the short-distance area on the road ahead without causing uneven light distribution.

In this embodiment, four lamp units 20A and 20B, four lamp units 40A and 40B, and four lamp units 60A and 60B are arranged in three stages. However, the number of those lamp units and arrangement thereof may be modified in accordance with the intended light distribution pattern, light intensity distribution and the like.

A first modified example of this embodiment of the invention will be described below.

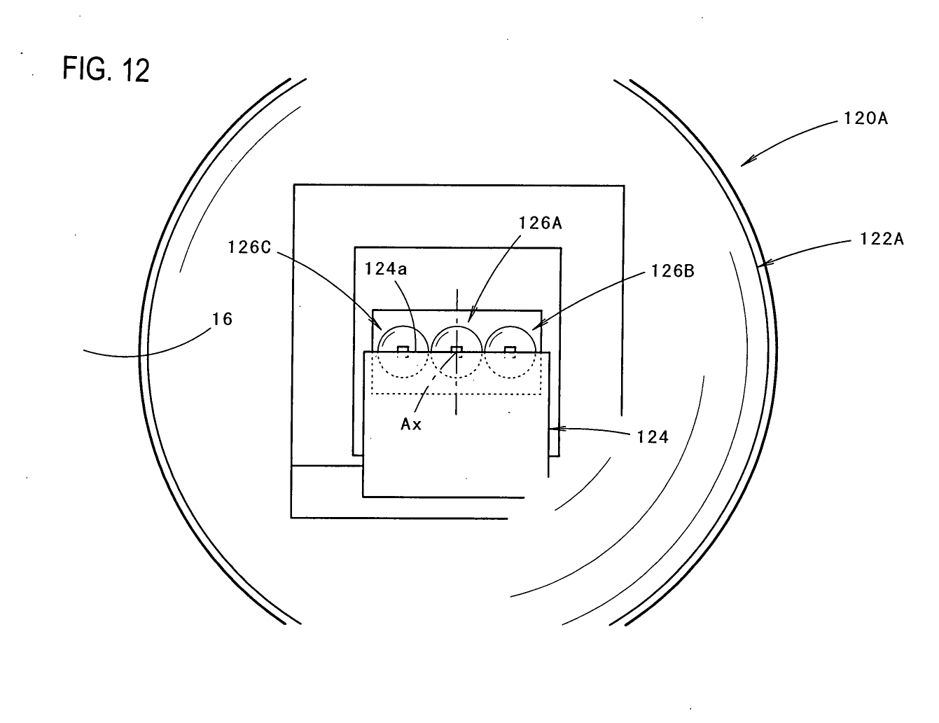

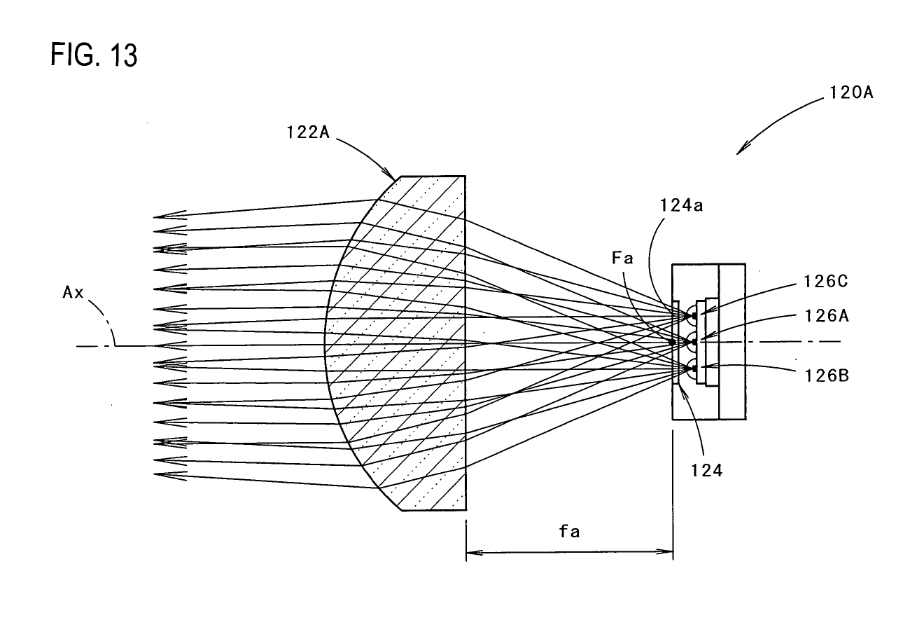

FIG. 12 shows a lamp unit 120A of the modified example, which is similar to FIG. 3. Also, FIG. 13 is a plan view showing the lamp unit 120A as a single unit.

Referring to these figures, the lamp unit 120A includes a projection lens 122A disposed on the optical axis Ax that extends in the longitudinal direction of the vehicle, a light shielding member 124 disposed in the proximity of a focal point Fa in the rear of the projection lens 122A, and three semiconductor light emitting elements 126A, 126B, and 126C positioned behind the light shielding member 124. The lamp unit 120A has a similar structure to the lamp unit 20A, including the focal distance fa of the projection lens 122A, except that three semiconductor light emitting elements 126A, 126B, and 126C are employed.

The three semiconductor light emitting elements 126A, 126B, and 126C are horizontally arranged at predetermined intervals along the upper edge 124a of the light shielding member 124. The semiconductor light emitting element 126A in the center is positioned on the optical axis Ax.

In the lamp unit 120A, an in the lamp unit 20A, each light emitted from the semiconductor light emitting elements 126A, 126B and 126C is partially shielded by the light shielding member 124, and is further radiated forward via the projection lens 122A.

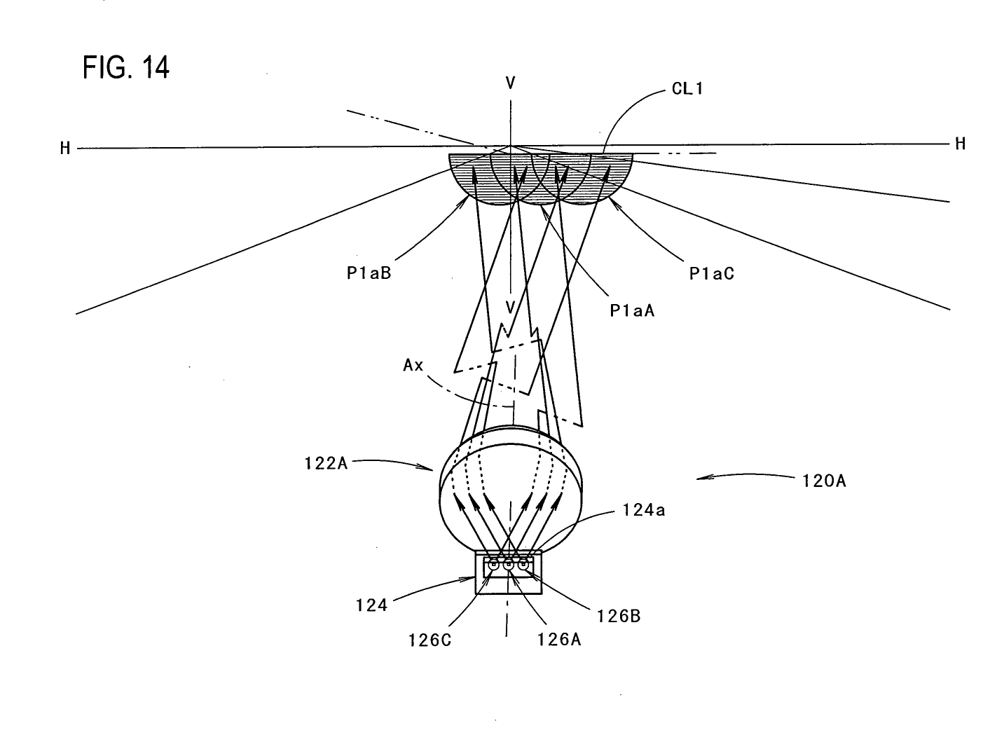

FIG. 14 is a perspective view to illustrate the geometry of light distribution patterns on the virtual vertical screen formed by the light radiated from the lamp unit 120A when seen from the backside.

Referring to the figure, the lamp unit 120A serves to form the pattern P1aA for horizontal cut-off line that is similar to the pattern P1a, which is formed by the lamp unit 20A, based on emitting light from the semiconductor light emitting element 126A on the optical axis Ax, and two patterns P1aB and P1aC for horizontal cut-off lines that partially overlap with the pattern P1aA based on emitting the light from the semiconductor light emitting elements 126B and 126C at both sides of the row.

In this modified example, a plurality of semiconductor light emitting elements 126A, 126B and 126C may further improve brightness of the light radiated from the lamp unit 120A and expand the area to be formed as the horizontal cut-off line CL1.

Also, the light shielding member 124 is commonly used for the plurality of the semiconductor light emitting elements 126A, 126B, and 126C. This allows the positional relationship among the light shielding positions corresponding to the respective semiconductor light emitting elements 126A, 126B and 126C to be accurately adjusted. As a result, the horizontal cut-off line CL1 can be formed with accuracy.

Needless to say, in this modified example, it is possible to apply a similar structure to the lamp unit 120A to the lamp unit for oblique cut-off line.

A second modified exmaple of the embodiment will be described below.

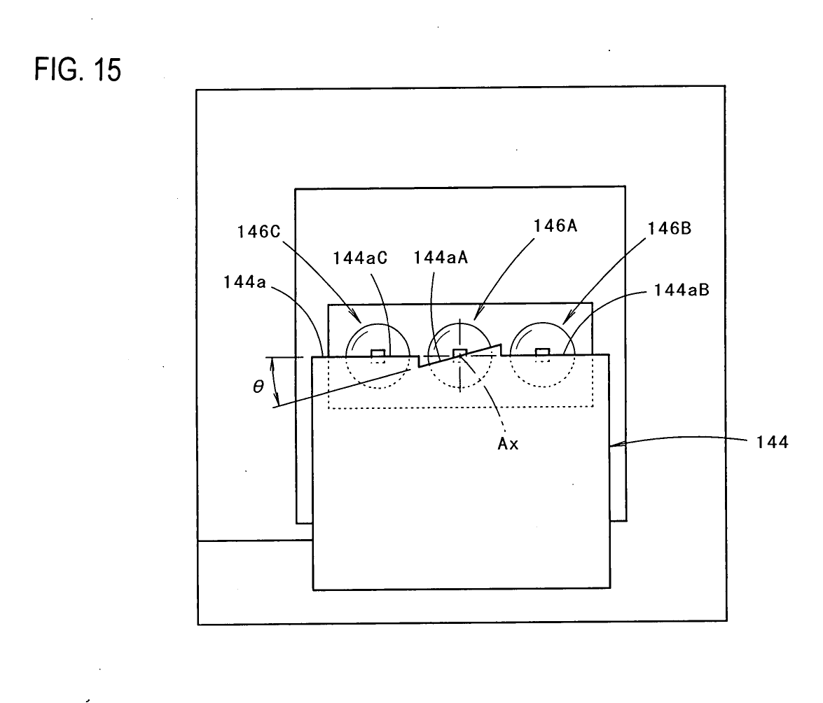

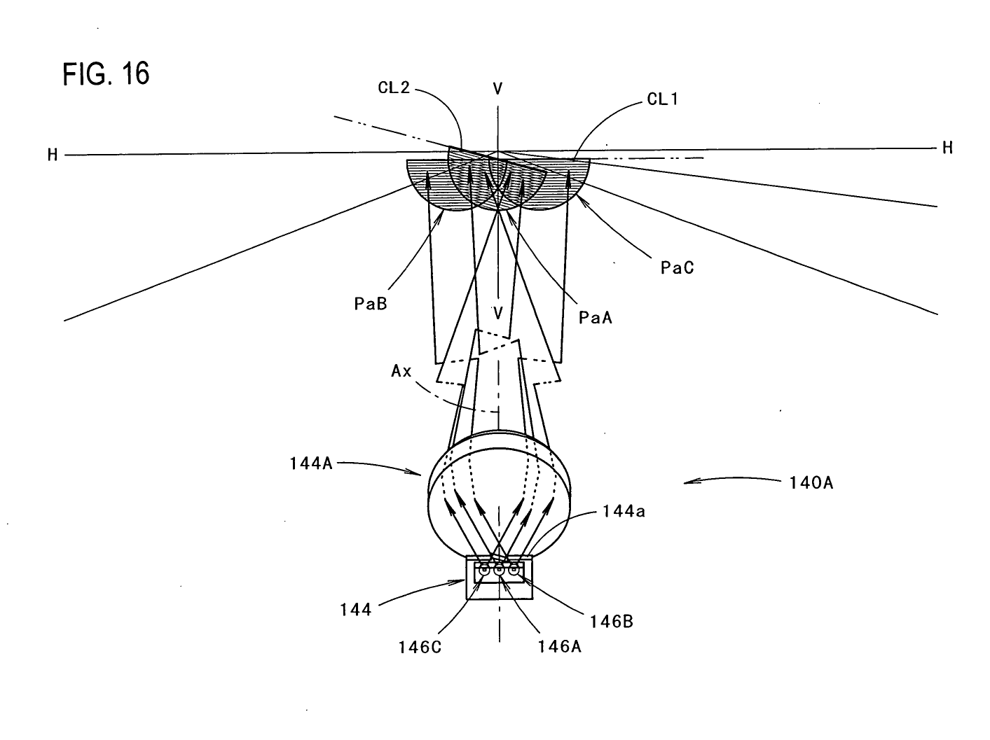

FIG. 15 shows an essential portion of a lamp unit 140A of the second modified example, which is substantially the same as FIG. 12. Also, FIG. 16 is a perspective view to illustrate the geometry of three patterns PaA, PaB, and PaC on the virtual vertical screen formed by the light radiated from the lamp unit 140A when perspectively seen from the backside.

Referring now to these figures, the lamp unit 140A includes a projection lens 142A disposed on the optical axis Ax that extends in the longitudinal direction of the vehicle, a light shielding member 144 disposed proximate to a focal point in the rear of the projection lens 142A, and three semiconductor light emitting elements 146A, 146B, and 146C arranged behind the light shielding member 144. The lamp unit 140A has a similar structure to the lamp unit 120A according to the first modified exmaple except structure of the light shielding member 144.

An upper edge 144a of the light shielding member 144 is composed of three segments. Specifically, segments 144aB and 144aC at both sides of the upper edge 144a, which correspond to the semiconductor light emitting elements 146B and 146C respectively, horizontally extend, as in the upper end edge 124a of the light shielding member 124. The other segment 144aA, which corresponds to the semiconductor light emitting element 146A, extends in a direction tiled with respect to the horizontal direction at a predetermined angle θ.

In the lamp unit 140A, as is the case with the lamp unit 120A, the light emitted from the respective semiconductor light emitting elements 146A, 146B and 146C is partially shielded by the light shielding member 144, and further transmitted forward via the projection lens 142A. In this case, light emission from the semiconductor light emitting element 146A in the center of the row on the optical axis Ax may form the pattern PaA for oblique cut-off line similar to the pattern P2a for oblique cut-off line by the lamp unit 40A. Also, light emission from the semiconductor light emitting elements 146B and 146C at both sides of the row may form two patterns PaB and PaC for horizontal cut-off lines, which partially overlap with the pattern P2A for oblique cut-off line.

In the second modified example, each of segments 144aA, 144aB and 144aC of the upper end edges 144a, each of which corresponds to the semiconductor light emitting elements 146A, 146B and 146C, is provided in a different shape. Accordingly, radiation of light from the lamp unit 144A may easily form the cut-off line with an arbitrary shape.

Additionally, the light shielding member 124 of the first modified example, and the light shielding member 144 of the second modified example are integrally formed, respectively. In the meantime, the light shielding member 124 and/or 144 may be individually configured for the respective three semiconductor light emitting elements 126A, 126B, and 126C and/or 146A, 146B, and 146C.

Further, in the embodiment and modified exmaples thereof, each of the semiconductor light emitting elements 26, 46, 66, 126A, and 146A is positioned on the optical axis Ax. However, such semiconductor light emitting elements may be provided on a position slightly apart from the optical axis Ax. In this case, each position of the semiconductor light emitting elements 26, 46, 66, 126A, and 146A may be offset upward from the optixal axis Ax. In doing so, amount of light that reaches the respective projection lenses 22A, 22B, 42A, 42B, 62A, 62B, 122A, and 142A increases because light around the optical axis Ax is not shielded by the respective light shielding members 24, 44, 124, and 144. Thus, this makes it possible to improve light efficiency of the lamp unit. Such arrangement may apply to the semiconductor light emitting elements 126B and 126C, and 146B and 146C positioned at both sides of the semiconductor light emitting elements 126A and 146A, respectively.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A lamp unit for a vehicular headlamp, comprising:
a light emitting element;
a projection lens disposed on an optical axis of the light emitting element; and
a shielding member disposed in the proximity of a focal point in the rear of the projection lens, wherein a upper edge of the shielding member is positioned proximate to the optical axis such that lower part of light emitted from the light light emitting element is shielded.

2. The lamp unit according to claim 1, wherein the projection lens is configured to cause light radiated from the light emitting element to slightly converge into the optical axis.

3. The lamp unit according to claim 1, wherein the upper edge of the shielding member is configured in a substantially horizontal direction.

4. The lamp unit according to claim 1, wherein the upper edge of the shielding member is configured to tilt at a predetermined angle against a horizontal direction.

5. The lamp unit according to claim 1, wherein a plurarity of the light emitting elements are provided.

6. The lamp unit according to claim 5, wherein the projection lens is disposed on an optical axis of one of the plurarity of light emitting elements.

7. The lamp unit according to claim 5, wherein the plurarity of light emitting elements are aligned in a horizontal direction.

8. Tha lamp unit according to claim 5, wherein the shielding member shields lower parts of light emitted each from the plurarity of light light emitting elements.

9. The lamp unit according to claim 5, wherein the shielding member has at least two sections associated with at least two of the plurarity of light emitting element, configured in a different shape.

10. The lamp unit according to claim 9, wherein one of the sections of the upper edge of the shielding member is configured to tilt at a predetermined angle against a horizontal direction.

11. A vehicular headlamp, comprising:
a first lamp unit; and
a second lamp unit,
wherein the first lamp unit comprising:
a first light emitting element;
a first projection lens disposed on an optical axis of the first light emitting element;
a first shielding member disposed in the proximity of a focal point in the rear of the projection lens, wherein a upper edge of the first shielding member is positioned proximate to the optical axisof the first light emitting element and configured in a substantially horizontal direction such that lower part-of light emitted from the first light light emitting element is shielded, and
wherein the second lamp unit comprising:
a second light emitting element;
a second projection lens disposed on an optical axis of the second light emitting element; and
a first shielding member disposed in the proximity of a focal point in the rear of the projection lens, wherein a upper edge of the shielding member is positioned proximate to the optical axis of the second light emitting element and configured to tilt at a predetermined angle against a horizontal direction such that lower part of light emitted from the second light light emitting element is shielded.

12. The vehicular headlamp according to claim 11, further comprising:
a third lamp unit, wherein the third lamp unit comprising:
a third light emitting element;
a third projection lens disposed on an optical axis of the third light emitting element; and
a plurarity of diffusion lens elements disposed in front of the third projection lens.

13. The vehicular headlamp according to claim 12, further comprising:
a lamp body having opening; and
a translucent cover attached to the opening of the lamp body, configured to form a lamp chamber, wherein the first lamp unit, the second lamp unit, and third lamp unit are disposed in the lamp chaber.

14. The vehicular headlamp according to claim 13, wherein the plurarity of diffusion lens is configured on the translucent cover.

15. The vehicular headlamp according to claim 12, wherein a plurarity of first lamp unit, a plurarity of second lamp unit, and a plurarity of third lamp unit are provided.

16. The vehicular headlamp according to claim 15, wherein each of the projection lenses of at least two of the plurarity of first lamp units is in different focal points.

17. The vehicular headlamp according to claim 15, wherein the plurarity of first lamp units, the plurarity of second lamp units, and the plurarity of third lamp units are arranged in a matrix.
